(19) United States
(12) Patent Application Publication
(10) Pub. No.: US 2004/0261478 A1
(43) Pub. Date: Dec. 30, 2004

(54) Door wireless access control system including reader, lock, and wireless access control electronics including wireless transceiver

(75) Inventor: Fred Conforti, (US)

Correspondence Address: MCANDREWS HELD & MALLOY, LTD, 500 WEST MADISON STREET, SUITE 3400, CHICAGO, IL, 60661

(73) Assignee: Recognition Source

(21) Appl. No.: 10/887,619

(22) Filed: Jul. 9, 2004

Related U.S. Application Data
(63) Continuation of application No. 10/193,513, filed on Jul. 11, 2002.
(60) Provisional application No. 60/326,179, filed on Sep. 30, 2001.

(51) Int. Cl. E05B 47/00

(52) U.S. Cl. 70/277

(57) ABSTRACT

The preferred embodiments of the present invention provide an improved access control system that provides additional security for the connection between an existing locking system and an access control system, for example, to prevent tampering. The security system preferably includes a control line shield to protect a control line running from an access reader to an external lock incorporated in a door, for example. The control line shield seals the control line into the interior of the door to prevent easy access for interference and tampering Additionally, the control line shield may be removed as necessary to provide service to the access system.

### RELATED APPLICATIONS

The present application claims priority from U.S. Provisional Patent Application No. 60/326,179 filed Sep. 30, 2001 entitled “General Access Control For Locking System.”

### BACKGROUND OF THE INVENTION

The present invention generally relates to an RF access control system. More particularly, the present invention relates to general access control for an RF access control system including an improved system of integrating an access reader, a locking mechanism, and access control electronics including a transceiver.

The applicants have filed several provisional patent applications setting forth various elements of a newly developed system for a wireless access control system. These applications include: U.S. Provisional Patent Application No. 60/326,179 filed Sep. 30, 2001 entitled “General Access Control For Locking System” and U.S. Provisional Patent Application No. 60/326,299 filed Sep. 30, 2001 entitled “Energy Saving Motor-Driven Locking Subsystem” both of which are hereby incorporated by reference in their entirety.

As set forth in the above-referenced applications, a wireless access control system may be installed at a door, for example, to provide access. The wireless access control system may include an access reader for receiving access information at the door and access control electronics including a transceiver for wirelessly relaying the access information to a remote entity to determine whether or not access is granted. The decision to grant or deny access may then be sent from the remote entity to the access control electronics via its transceiver. When the access control electronics receives a signal back through its transceiver, it may then send a signal to open the door's lock.

One embodiment set forth in the above applications shows the integration of an electric lock with an access reader control and wireless access control electronics including a transceiver to make a wireless access control system at the door. Integrating the elements of the access control system at the door and making it wireless may be preferable to wiring individual components around the door and then wiring back to a panel. However, the integration of the electric lock with the rest of the wireless access control system at the door may create security concerns. For example, the connection between the electric lock and the access control electronics may be vulnerable to interference or attack.

Thus, a need exists for a system and method for providing additional security for the connection between the electric lock and the access control electronics, for example, to prevent tampering. A need especially exists for the protection of command or control signals traveling from the access control electronics to the electric lock.

### SUMMARY OF THE INVENTION

The present invention provides an improved access control system with a control line shield for use in a wireless access control system. The control line shield may protect a control line running from the access control electronics to the electric lock incorporated in a door, for example. The control line shield seals the control line into the interior of the door to prevent easy access. Thus, the control line shield helps to keep the control line from the access control electronics to the electric lock safe from outside interference and tampering. Additionally, the control line shield may be removed as necessary to provide service to the access system.

These and other features of the present invention are discussed or apparent in the following detailed description of the preferred embodiments of the invention.

### BRIEF DESCRIPTION OF THE DRAWINGS

FIG. 1 illustrates an improved access control system with control line shield for a wireless access control system according to a preferred embodiment of the present invention.

FIG. 2 illustrates a perspective view of the installation of the wireless access control system according to a preferred embodiment of the present invention.

FIG. 3 illustrates a side view of the installation of the wireless access control system according to a preferred embodiment of the present invention.

FIG. 4 illustrates a perspective view of an alternative embodiment of the installation of a wireless access control system.

### DETAILED DESCRIPTION OF THE PREFERRED EMBODIMENTS

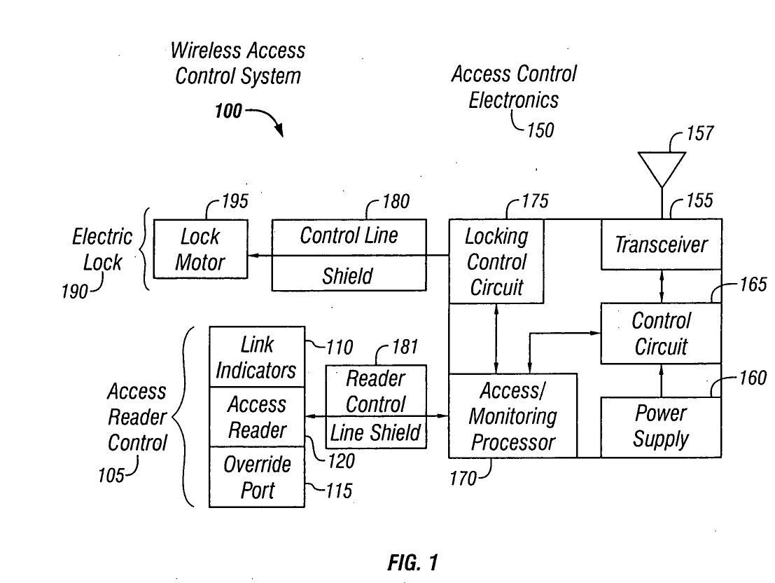

FIG. 1 illustrates an improved wireless access control system 100 with control line shield 180 for a wireless access control system according to a preferred embodiment of the present invention. The wireless access control system 100 includes an access reader control 105, access control electronics 150, a control line shield 180, a reader control line shield 181 and an electric lock 190.

The access reader control 105 includes one or more link indicators 110, an override port 115, and an access reader 120. The access control electronics 150 includes a transceiver 155, an antenna 157, a power supply 160, which may be external, a control circuit 165, an access/monitoring processor 170, and a locking control circuit 175. The lock 190 includes a lock motor 195.

The power supply 160 provides power to the access control system 100 including powering the transceiver 155, the control circuit 165, the locking control circuit 175, the electric motor 195, the access reader control 105, and the access/monitoring processor 170. The power supply 160 may be an internal battery or other internal type of power supply. Alternatively, an external AC power supply may be employed. The transceiver 155 is coupled to the antenna 157 to allow RF signals to be sent and received from the wireless access control system 100 to an external point. The control circuit 165 sends and receives data from the access/monitoring processor 170 and the transceiver 155. Additionally, the control circuit 165 regulates the power supplied to the access reader control 105 by the power supply 160.

The access/monitoring processor 170 sends signals to and receives signals from the control circuit 165 and the access reader 120 and sends signals to and receives signals from the locking control circuit 175. The access/monitoring processor 170 receives power from the control circuit 165. The access/monitoring processor 170 in turn powers the link indicators 110, locking control circuit 175, override port 115, and access reader 120. The access/monitoring processor 170 additionally controls the link indicators 110 and receives data from the access reader 120 as well as the override ports 115. The access/monitoring processor 170 also sends commands to the locking control circuit 175 and receives data from the locking control circuit 175.

The link indicators 110 may be a graphical or audible signal that the wireless access control system 100 has read an access signal, transmitted the access signal to the remote access control panel, received a confirmation, or activated the locking member, for example. The override port 115 may be used, for example, by a technician to provide service or power to the wireless access control system. The access reader 120 may read access information to aid in determining whether access should be granted. The access information may be of any type, but is preferably a biometric, proximity, magstripe or similar identifier. The lock motor 195 may be of any type and may control a locking bar or other security device, for example.

The locking control circuit 175 is coupled to and provides control for the lock motor 195. The coupling between the locking control circuit 175 and the lock motor 195 is protected by a control line shield 180 which serves to reduce access to the control line between the locking control circuit 175 and the lock motor 195. The control line shield 180 may, for example, be a physical shield that limits access to the control line, such as a metal plate or a pre-formed housing within a door.

In operation, an access signal may be received from the access reader 120. The access signal is then relayed to the access/monitoring processor 170. The access/monitoring processor 170 then sends the access signal to control circuit 165 which passes the signal to the transceiver 155. The transceiver 155 transmits the access signal to a database of authorized access signals (e.g., an access control panel). If the correct access data is in the database, a confirmation is transmitted to the transceiver 155. The confirmation is relayed from the transceiver 155 to the access/monitoring processor 170 through the control circuit 165. The access/monitoring processor 170 then sends a control signal to the locking control circuit 175. When the locking control circuit 175 receives the control signal, the locking control circuit 175 activates the lock motor 195 to allow access. The connecting line between the locking control circuit 175 to the lock motor 195 is protected by the control line shield 180.

As shown in FIG. 1, the power supply 160 is not contained within the access reader control 105, and the access reader control 105 receives power from the power supply 160 via a link that provides power and communications between the access reader control 105 and the access control electronics 150. Alternatively, the power supply 160 may be included as part of the access reader control 105. Additionally, any or all of the functionality of the access control electronics 150 may be integrated with the access reader control 105.

Additionally, in FIG. 1, the wiring is shown as running between the access reader control 105 and the access control electronics 150 separately from the wiring running between the external lock 190 and the access control electronics 150. The wiring between the access reader control 105 and the access control electronics 150 is protected by a reader line shield 181. The reader line shield 181 serves to limit access to the wiring to reduce undesired tampering with the system. In one case the reader line shield may be the door itself as the wiring between the access reader control 105 and the access control electronics passes through the door. Alternatively, the wiring may run from the access control electronics 150 to the access reader control 105 to the external lock. In this instance, the control line shield 180 is configured to protect the wiring from the access reader control 105 to the external lock 195. As an additional alternative, both the access reader control 105 and the access control electronics 150 may be wired to the external lock 190. In this instance, the control line shield 180 protects both sets of wiring.

Further discussion of various elements of the wireless access control system 100 are discussed in U.S. Provisional Patent Application No. 60/326,179 filed Sep. 30, 2001 entitled “General Access Control For Locking System” and U.S. Provisional Patent Application No. 60/326,299 filed Sep. 30, 2001 entitled “Energy Saving Motor-Driven Locking Subsystem” which are hereby incorporated by reference in their entirety.

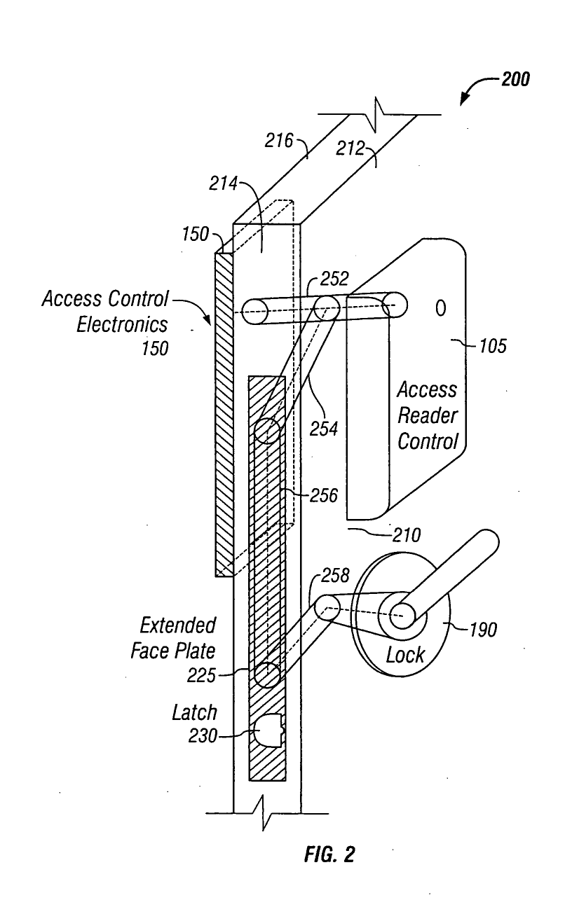

FIG. 2 illustrates an installation 200 of the wireless access control system 100 according to a preferred embodiment of the present invention. The installation 200 includes a door 210, an access reader control 105, access control electronics 150, an external lock 190 and a control line shield embodied as an extended face plate 225. Additionally, the door itself acts as a reader line shield between the access control reader 105 and the access control electronics 150. The external lock 190 includes a lock motor (not shown) that controls a latch 230 to lock or unlock the door 210. The door 210 includes a door front face 212 and a door edge 214 and a door back face 216.

Additionally, several channels have been formed in the door 210 to allow the passage of wiring a through-door channel 252, and out-to-edge channel 254, an along-edge channel 256, and an in-to-lock channel 258. The through-door channel 252 serves to provide a passage for wiring connecting the access reader control 105 and the access control electronics 150. Thus, as shown in FIG. 2, the access reader control 105 and the access control electronics 150 are connected by wiring running through the body of the door 210 perpendicular to the plane of the face of he door 210. The wiring connecting the access reader control 105 and the access control electronics 150 is thus typically safe from outside interference and tampering because is it concealed within the core of the door 210.

Also, as shown in FIG. 2, the access reader control 105 and/or access control electronics 150 may be connected by wiring to the external lock 190. That is, the through-door channel 252 intersects with the out-to-edge channel 254 to allow the passage of wiring out to the door edge 214. At the door edge 214, the wiring passes from the out-to-edge channel 254 to the along-edge channel 256 which is preferably inset into the face of the door edge 214. The wiring then passes from the along-edge channel 256 to the in-to-lock channel 258 and then to the electric lock 190.

Thus, starting at the access reader control 105, the wiring preferably runs substantially perpendicular to the door face 212 through channel 252 then parallel to the door face 212 and to the door edge 214. The wiring then preferably runs along the door edge 214 downward to the height of the lock and then preferably runs from the door edge 214 inward substantially parallel to the door face 212 to the external lock 190.

In FIG. 2, the wiring that runs along the door edge 214 is protected by a control line shield, in this case and extended face plate 225. The extended face plate 225 differs from the standard face plate because the extended face plate 225 has been increased in the vertical dimension, as compared to a standard faceplate, to protect the wiring running along the door edge 214. Typically, in installing the extended face plate 225, the edge of the door is modified to provide a recess into which the wiring and the face plate 225 may be fitted. Thus, the face plate 225 is preferably flush with the edge of the door. The extended faceplate 225 in this case is the control line shield 180.

Thus, the control line shield 180 helps to keep the control line that runs from the access reader control 105 to the electric lock 190 safe from outside interference and tampering. The control line shield 180 seals the control line into the interior of the door to prevent easy access. Additionally, the control line shield 180 may be removed as necessary to provide service to the wireless access control system 100.

In addition to the single, larger face plate 225 shown in FIG. 1, the control line shield 180 may take the form of two separate face plates, a first face plate that is standard for the lock 190 and an additional extension face plate. The extension face plate then extends from the top of the standard face plate to cover the additional vertical run of the wiring.

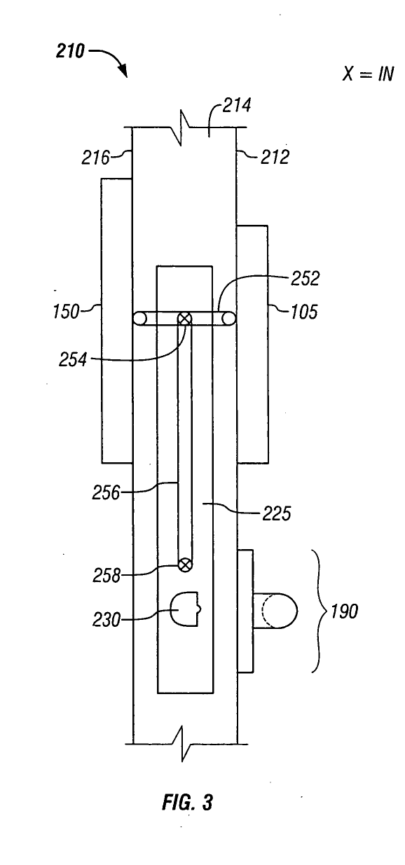

FIG. 3 illustrates a side view of the installation of the access control system according to a preferred embodiment of the present invention. As shown in FIG. 3, the access reader control 105 and the access control electronics 150 may be wired together through the through-door channel 252. Wiring may then be drawn from either the access reader control 105 or the access control electronics 150 through the through-door channel 252 and then through the out-to-edge channel 254 to the door edge 214. The wiring may then pass along the door edge 214 in the along-edge channel 256 to the in-to-lock channel 258 to the electric lock 190.

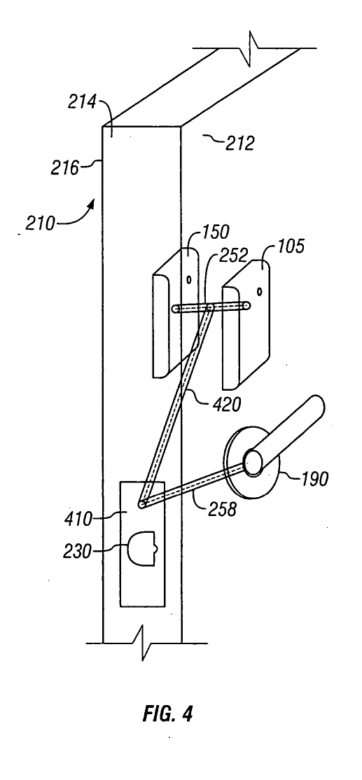

FIG. 4 illustrates a perspective view of an alternative embodiment of the installation of the access control system. FIG. 4 includes the access reader control 105, access control electronics 150 and electric lock 190 with latch 230 installed in the door 210 which includes the door front face 212, the door edge 214 and the door back face 216. FIG. 4 also includes the through-door channel 252 and in-to-lock channel 258.

However, instead of the extended face plate 225 of FIGS. 2 and 3, FIG. 4 includes a standard faceplate 410. Additionally, instead of the out-to-edge channel 254 and the along-edge channel 256 of FIGS. 2-3, FIG. 4 includes a single slope-to-edge channel 420.

In operation, system FIG. 4 performs similarly to the system FIGS. 2-3, except that the single slope-to-edge channel 420 eliminates the need for the out-to-edge channel 254 and the along-edge channel 256. Additionally, the slope-to-edge channel 420 preferably emerges at the door edge 214 behind the faceplate 410. However, the faceplate 410 is typically a standard faceplate such as may have been previously installed in the door 210. Thus, the extended faceplate 225 is not necessary to prevent access to the control line and the standard faceplate performs as the control line shield 180.

However, the embodiment of FIG. 4 may be less preferable because the slope-to-edge channel 420 may be difficult to form or may compromise the integrity of the door or may be difficult to service. Conversely, the embodiment of FIG. 4 may be more preferable in instances when less modification to the door edge 214 is desired.

Alternatively, a the channel may be a hole or passage formed from the access reader control 105 or access control electronics 150 downward directly to the electric lock 190 through the door 210. However, such a hole or passage may be exceedingly difficult to form and may significantly compromise the integrity of the door, as well as being difficult to service.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features which come within the spirit and scope of the invention.

1. A security system for providing security between a locking system and wireless access control electronics or an access reader control, said security system including:
a control line extending between a locking system and at least one of access control electronics and an access reader control, said control line relaying control signals from said at least one of access control electronics and an access reader control to said locking system;
a control line shield preventing physical access to said control line; and
an electric lock in said locking system, said electric lock able to perform both a locking operation and an unlocking operation, wherein said electric lock performs one of a locking operation and an unlocking operation in response to said control signals,
wherein said access reader control reads access information using a proximity reader to determine said control signals to be transmitted to said electric lock.

2. The system of claim 1 wherein said security system is installed in operation with a door having a door edge.

3. The system of claim 2 wherein said security system is installed with said access reader control mounted at one side of said door and said access control electronics mounted at a different side of said door.

4. The system of claim 3 wherein said control line runs from said access control electronics to said door edge.

5. The system of claim 4 wherein said control line runs along said door edge to said locking system.

6. The system of claim 4 wherein said control line is covered by said control line shield at said door edge.

7. The system of claim 2 wherein said control line shield is a face plate mounted in said door edge of said door.

8. The system of claim 2 wherein said reader control line runs through said door allowing said door to operate as a reader control line shield.

9. The system of claim 4 wherein said face plate operates in conjunction with a preexisting face plate and latch to prevent physical access to said control line.

10. The system of claim 2 wherein said control line shield is a channel in the interior of said door.

11. The system of claim 3 wherein said control line shield is a channel in the interior of said door.

12. The system of claim 10 wherein said channel emerges from said door edge behind a preexisting face plate.

13. The system of claim 10 wherein said channel runs from said access control system to said locking system without emerging from said door.

14. The system of claim 11 wherein said channel runs from said access control electronics to said access reader control without emerging from said door.

15. A method for providing security between a locking system and at least one of an access control electronics and an access reader control, said method including:
extending a control line between a locking system and at least one of access control electronics and an access reader control;
reading access information at said access reader control using a biometric reader to determine a control signal;
relaying said control signals from said at least one of access control electronics and an access reader control to said locking system using said control line;
performing one of a locking operation and an unlocking operation at an electric lock in said locking system in response to said control signals wherein said electric lock is able to perform both a locking operation and an unlocking operation; and
preventing physical access to said control line.

16. The method of claim 15 wherein said extending step includes extending said control line from said at least one of access control electronics and an access reader control to a locking system through a door having a door edge.

17. The method of claim 15 wherein said preventing step includes preventing physical access to said control line by imposing a control line shield.

18. The method of claim 17 wherein said control line shield is a face plate mounted in the edge of said door.

19. The method of claim 18 wherein said face plate operates in conjunction with a preexisting face plate to prevent physical access to said control line.

20. The method of claim 16 wherein said control line shield is a channel in the interior of said door.

21. The method of claim 20 wherein said channel emerges from said door edge behind a preexisting face plate.

22. The method of claim 20 wherein said channel emerges from said door edge behind a preexisting face plate or an extended face plate.

23. The method of claim 20 wherein said channel runs from said access control system to said locking system without emerging from said door.

24. A method for providing security between an access reader control and access control electronics, said method including:
extending a reader control line between access control electronics and an access reader control; and
receiving access information at said access reader control to aid in determining whether access should be granted, wherein said access information is received at said access reader control from a magnetic stripe card reader;
transmitting access signals based on said access information from said access reader control to said access control electronics using said reader control line; and
preventing physical access to said reader control line.

25. The method of claim 20 wherein said preventing step includes preventing physical access to said control line by imposing a control line shield.

26. The method of claim 21 wherein said control line shield is a channel in the interior of said door.

27. The method of claim 22 wherein said channel runs from said access control system to said locking system without emerging from said door.

28. A security system for providing security between a locking system and wireless access control electronics or an access reader control, said security system including:
a control line extending between a locking system and at least one of access control electronics and an access reader control, said control line relaying control signals from said at least one of access control electronics and an access reader control to said locking system;
a control line shield preventing physical access to said control line; and
an electric lock in said locking system, said electric lock able to perform both a locking operation and an unlocking operation, wherein said electric lock performs one of a locking operation and an unlocking operation in response to said control signals.

29. A method for providing security between a locking system and at least one of an access control electronics and an access reader control, said method including:
extending a control line between a locking system and at least one of access control electronics and an access reader control;
relaying said control signals from said at least one of access control electronics and an access reader control to said locking system using said control line;
performing one of a locking operation and an unlocking operation at an electric lock in said locking system in response to said control signals, wherein said electric lock is able to perform both a locking operation and an unlocking operation; and
preventing physical access to said control line.

30. A method for providing security between an access reader control and access control electronics, said method including:
extending a reader control line between access control electronics and an access reader control; and
receiving access information at said access reader control to aid in determining whether access should be granted,
transmitting access signals based on said access information from said access reader control to said access control electronics using said reader control line; and
preventing physical access to said reader control line.
